(19) United States
(12) Patent Application Publication
(10) Pub. No.: US 2013/0308027 A1
(43) Pub. Date: Nov. 21, 2013

(54) SYSTEMS AND METHODS FOR GENERATING METADATA IN STACKED-CHIP IMAGING SYSTEMS

(71) Applicant: Aptina Imaging Corporation, (US)

(72) Inventor: Robin Jenkin, Morgan Hill, CA (US)

(73) Assignee: Aptina Imaging Corporation, George Town (KY)

(21) Appl. No.: 13/886,528

(22) Filed: May 3, 2013

Related U.S. Application Data
(60) Provisional application No. 61/642,362, filed on May 3, 2012.

(51) Int. Cl. H04N 5/347

(52) U.S. Cl. CPC H04N 5/347
USPC 348/302

(57) ABSTRACT

Imaging systems may be provided with stacked-chip image sensors. A stacked-chip image sensor may include a vertical chip stack that includes an array of image pixels, analog control circuitry and storage and processing circuitry. The control circuitry or the processing circuitry may include metadata generation circuitry and image data output control circuitry that control the processing of blocks of image data from blocks of image pixels in the image pixel array. The metadata generation circuitry may generate metadata for a current image block and provide the generated metadata to the image data output control circuitry. The image data output control circuitry may output image blocks that have been flagged for readout, flagged for enhanced image processing, or otherwise flagged for transmission in the generated metadata.

This application claims the benefit of provisional patent application No. 61/642,362, filed, May 3, 2012, which is hereby incorporated by reference herein in its entirety.

### BACKGROUND

This relates generally to imaging systems, and more particularly, to imaging systems with stacked-chip image sensors.

Image sensors are commonly used in imaging systems such as cellular telephones, cameras, and computers to capture images. In a typical arrangement, an image sensor is provided with an array of image sensor pixels and control circuitry for operating the image sensor pixels. In a conventional imaging system the control circuitry is laterally separated from the image sensor pixels on a silicon semiconductor substrate. Each row of image sensor pixels typically communicates with the control circuitry along a common metal line on the silicon semiconductor substrate. Similarly, each column of image sensor pixels communicates with the control circuitry along a common metal line.

In this type of system, conventional readout schemes require an image to be output serially from the image sensor. Image data from every pixel is then processed in series in the same work flow. This type of serial processing can limit the efficiency with which image data is processed and analyzed.

It would therefore be desirable to be able to provide improved imaging systems with enhanced image data processing efficiency.

### BRIEF DESCRIPTION OF THE DRAWINGS

FIG. 1 is a diagram of an illustrative electronic device in accordance with an embodiment of the present invention.

FIG. 2 is a top view of an illustrative image sensor array having a plurality of stacked-chip image sensors each having vertical conductive interconnects for coupling to control circuitry in accordance with an embodiment of the present invention.

FIG. 3 is a diagram of an illustrative image sensor pixel in accordance with an embodiment of the present invention.

FIG. 4 is a diagram of an illustrative stacked-chip image sensor having an image pixel array in a vertical chip stack that includes analog control circuitry and storage and processing circuitry coupled by vertical metal interconnects in accordance with an embodiment of the present invention.

FIG. 5 is a flow diagram showing how image data is read out and processed in a conventional image sensor.

FIG. 6 is a flow diagram showing how blocks of image data can be read out and processed in parallel in a stacked-chip image sensor in accordance with an embodiment of the present invention.

FIG. 7 is a flow diagram showing how metadata may be generated for blocks of image data in a stacked-chip image sensor in accordance with an embodiment of the present invention.

FIG. 8 is a block diagram of a processor system that may include a stacked-chip image sensor with metadata generation capabilities for parallel processing of blocks of image data in accordance with an embodiment of the present invention.

### DETAILED DESCRIPTION

Digital camera modules are widely used in imaging systems such as digital cameras, computers, cellular telephones, or other electronic devices. These imaging systems may include image sensors that gather incoming light to capture an image. The image sensors may include arrays of image sensor pixels. The pixels in an image sensor may include photosensitive elements such as photodiodes that convert the incoming light into digital data. Image sensors may have any number of pixels (e.g., hundreds or thousands or more). A typical image sensor may, for example, have hundreds of thousands or millions of pixels (e.g., megapixels).

Each image sensor may be a stacked-chip image sensor having a vertical chip stack that includes an image pixel array, control circuitry, and digital processing circuitry. The analog control circuitry may be coupled to the image pixel circuitry using vertical conductive paths (sometimes called vertical metal interconnects or vertical conductive interconnects) such as through-silicon vias in a silicon semiconductor substrate. The digital processing circuitry may be coupled to the analog control circuitry using vertical metal interconnects such as through-silicon vias in the silicon semiconductor substrate. Vertical metal interconnects may be formed at an edge of an image pixel array or throughout an image pixel array. Vertical metal interconnects may be configured to couple rows of image pixels, columns of image pixels, blocks of image pixels, other groups of image pixels, or individual image pixels to the analog control circuitry.

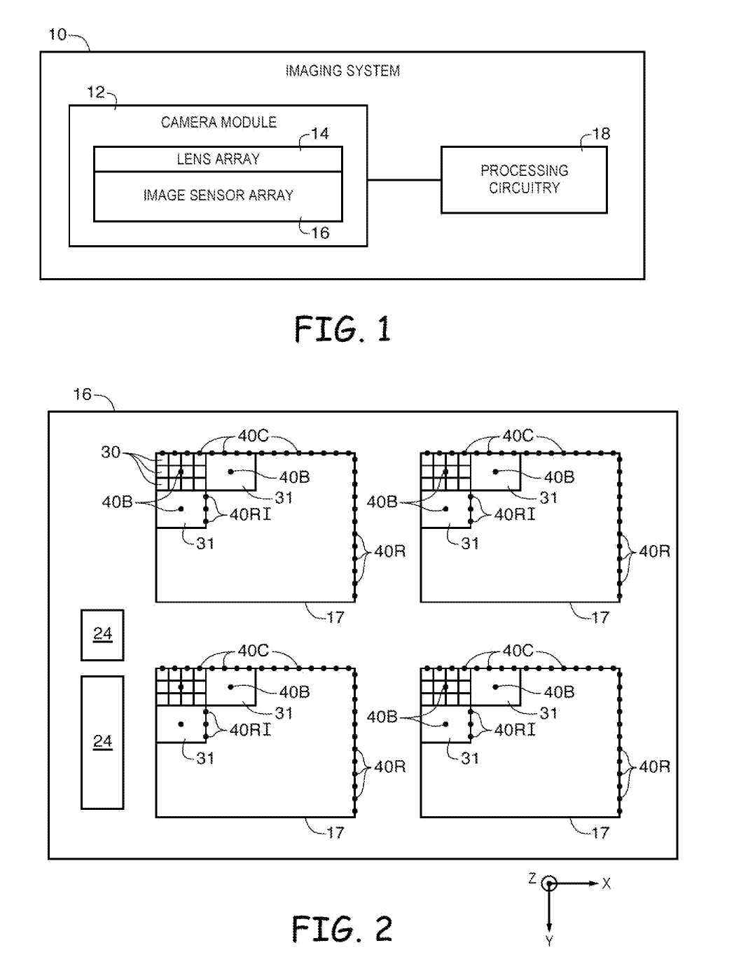

FIG. 1 is a diagram of an illustrative imaging system that uses a stacked-chip image sensor to capture images. Imaging system 10 of FIG. 1 may be a portable imaging system such as a camera, a cellular telephone, a video camera, or other imaging device that captures digital image data. Camera module 12 may be used to convert incoming light into digital image data. Camera module 12 may include an array of lenses 14 and a corresponding array of stacked-chip image sensors 16. Lenses 14 and stacked-chip image sensors 16 may be mounted in a common package and may provide image data to processing circuitry 18.

Processing circuitry 18 may include one or more integrated circuits (e.g., image processing circuits, microprocessors, storage devices such as random-access memory and non-volatile memory, etc.) and may be implemented using components that are separate from camera module 12 and/or that form part of camera module 12 (e.g., circuits that form part of an integrated circuit that includes image sensors 16 or an integrated circuit within module 12 that is associated with image sensors 16). Image data that has been captured by camera module 12 may be processed and stored using processing circuitry 18. Processed image data may, if desired, be provided to external equipment (e.g., a computer or other device) using wired and/or wireless communications paths coupled to processing circuitry 18.

Image sensor array 16 may contain one or more stacked-chip image sensors. Each stacked-chip image sensor may have an array of image sensor pixels (sometimes referred to as image pixels or pixels). The image pixels may be configured to receive light of a given color by providing each image pixel array with a corresponding color filter. The color filters that are used for image sensor pixel arrays in the image sensors may, for example, include red filters, blue filters, and green filters. An image pixel array may have a patterned array of color filters having multiple color filter elements (e.g., red color filters, blue color filters, and green color filters) or image sensor array 16 may include a color filter of a single color filter for each of multiple pixel arrays (e.g., an image sensor may have a red pixel array, a green pixel array, and a blue pixel array). If desired, other color filters such as white color filters, dual-band IR cutoff filters (e.g., filters that allow visible light and a range of infrared light emitted by LED lights), etc. may also be used.

An array of stacked-chip image sensors may be formed on one or more semiconductor substrates. With one suitable arrangement, which is sometimes described herein as an example, each vertical layer of a stacked-chip image sensor array (e.g., the image pixel array layer, the control circuitry layer, or the processing circuitry layer) is formed on a common semiconductor substrate (e.g., a common silicon image sensor integrated circuit die). Each stacked-chip image sensor may be identical. For example, each stacked-chip image sensor may be a Video Graphics Array (VGA) sensor with a resolution of 480×640 sensor pixels (as an example). Other types of image sensor may also be used for the image sensors if desired. For example, images sensors with greater than VGA resolution or less than VGA resolution may be used, image sensor arrays in which the image sensors are not all identical may be used, etc. If desired, image sensor array 16 may include a single stacked-chip image sensor.

As shown in FIG. 2, image sensor array 16 may include multiple image pixel arrays such as image pixel arrays 17 that are formed on a single integrated circuit die. In the example of FIG. 2, image sensor array 16 includes four stacked-chip image sensors.

However, this is merely illustrative. If desired, image sensor array 16 may include a single stacked-chip image sensor, two stacked-chip image sensors, three stacked-chip image sensors, or more than four stacked-chip image sensors.

Each pixel array 17 may have image sensor pixels such as image pixels 30 that are arranged in rows and columns. Image sensor pixel arrays 17 may have any suitable resolution (e.g., 640×480, 4096×3072, etc.). Image sensor pixels 30 may be formed on a planar surface (e.g., parallel to the x-y plane of FIG. 2) of a semiconductor substrate such as a silicon die.

As shown in FIG. 2, each image pixel array 17 may be provided with a plurality of vertical conductive paths such as conductive interconnects 40 (e.g., metal lines, through-silicon vias, etc. that run perpendicular to the x-y plane of FIG. 2) such as row interconnects 40R, column interconnects 40C, pixel block interconnects 40B, and internal row interconnects 40RI. Row interconnects 40R, column interconnects 40C, pixel block interconnects 40B, and internal row interconnects 40RI may each be configured to couple one or more image pixels 30 to control circuitry (e.g., analog control circuitry) that is vertically stacked with the associated image pixel array (e.g., stacked in the z-direction of FIG. 2).

For example, a row interconnect 40R may couple an associated row of image sensor pixels 30 to control circuitry such as row driver circuitry that is vertically stacked with an image pixel array 17. Row interconnects 40R may be coupled to pixel rows along an edge of image pixel array 17. Each pixel row may be coupled to one of row interconnects 40R. A column interconnect 40C may couple an associated column of image sensor pixels 30 to control circuitry that is vertically stacked with an image pixel array 17. A block interconnect 40B may couple an associated block (e.g., blocks 31) of image sensor pixels 30 (e.g., a 4×4 pixel block, an 8×8 pixel block, a 16×16 pixel blocks, a 32×32 pixel block, etc.) to control circuitry such as analog-to-digital conversion circuitry that is vertically stacked with an image pixel array 17. An internal row interconnect 40RI may couple a portion of a row of image sensor pixels 30 to control circuitry that is vertically stacked with an image pixel array 17. Each pixel row in image pixel array 17 may be coupled to multiple internal row interconnects 40RI. Internal row interconnects 40RI may be coupled to image pixels 30 along an edge of one or more pixel blocks 31 and may couple the pixels 30 of that pixel block 31 to the control circuitry.

Row interconnects 40R, column interconnects 40C, pixel block interconnects 40B, and internal row interconnects 40RI may each be formed from, for example, through-silicon vias that pass from a first silicon semiconductor substrate (e.g., a substrate having an image pixel array) to a second silicon semiconductor substrate (e.g., a substrate having control and readout circuitry for the image pixel array).

Image sensor array 16 may, if desired, also include support circuitry 24 that is horizontally (laterally) separated from image pixel arrays 17 on the semiconductor substrate.

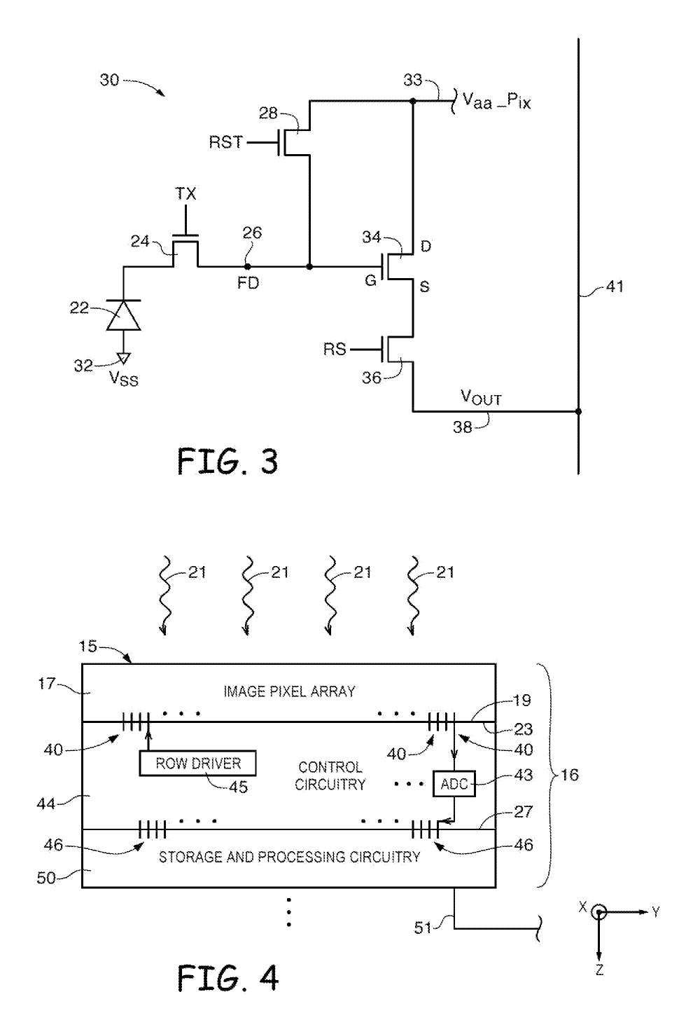

Circuitry in an illustrative pixel of one of the stacked-chip image pixel arrays in sensor array 16 is shown in FIG. 3. As shown in FIG. 3, pixel 30 may include a photosensitive element such as photodiode 22. A positive pixel power supply voltage (e.g., voltage Vaa_pix) may be supplied at positive power supply terminal 33. A ground power supply voltage (e.g., Vss) may be supplied at ground terminal 32. Incoming light is collected by photodiode 22 after passing through a color filter structure. Photodiode 22 converts the light to electrical charge.

Before an image is acquired, reset control signal RST may be asserted. This turns on reset transistor 28 and resets charge storage node 26 (also referred to as floating diffusion FD) to Vaa. The reset control signal RST may then be deasserted to turn off reset transistor 28. After the reset process is complete, transfer gate control signal TX may be asserted to turn on transfer transistor (transfer gate) 24. When transfer transistor 24 is turned on, the charge that has been generated by photodiode 22 in response to incoming light is transferred to charge storage node 26.

Charge storage node 26 may be implemented using a region of doped semiconductor (e.g., a doped silicon region formed in a silicon substrate by ion implantation, impurity diffusion, or other doping techniques). The doped semiconductor region (i.e., the floating diffusion FD) exhibits a capacitance that can be used to store the charge that has been transferred from photodiode 22. The signal associated with the stored charge on node 26 is conveyed to row select transistor 36 by source-follower transistor 34.

If desired, other types of image pixel circuitry may be used to implement the image pixels of sensors 16. For example, each image sensor pixel 30 (see, e.g., FIG. 1) may be a three-transistor pixel, a pin-photodiode pixel with four transistors, a global shutter pixel, etc. The circuitry of FIG. 3 is merely illustrative.

When it is desired to read out the value of the stored charge (i.e., the value of the stored charge that is represented by the signal at the source S of transistor 34), select control signal RS can be asserted. When signal RS is asserted, transistor 36 turns on and a corresponding signal Vout that is representative of the magnitude of the charge on charge storage node 26 is produced on output path 38. In a typical configuration, there are numerous rows and columns of pixels such as pixel 30 in the image sensor pixel array of a given image sensor. A conductive path such as path 41 can be associated with one or more pixels such as a column of pixels or a block of pixels.

When signal RS is asserted in a given row, a given block or a given portion of a row of pixels, path 41 can be used to route signal Vout from that row to readout circuitry. Path 41 may, for example, be coupled to one of column interconnects 40C or one of block interconnects 40B. Image data such as charges collected by photosensor 22 may be passed along one of column interconnects 40C or block interconnects 40B to associated control and readout circuitry that is vertically stacked with image pixel arrays 17.

As shown in FIG. 4, an image pixel array such as image pixel array 17 may be formed in a vertical chip stack with analog control and readout circuitry such as control circuitry 44 and digital processing circuitry such as storage and processing circuitry 50. Image pixel array 17 may be a front-side illuminated (FSI) image pixel array in which image light 21 is received by photosensitive elements through a layer of metal interconnects or may be a backside illuminated (BSI) image pixel array in which image light 21 is received by photosensitive elements formed on a side that is opposite to the side on which the layer of metal interconnects is formed.

Image pixel array 17 may be formed on a semiconductor substrate that is configured to receive image light 21 through a first surface (e.g., surface 15) of the semiconductor substrate. Control circuitry 44 may be formed on an opposing second surface (e.g., surface 19) of the semiconductor substrate. Control circuitry 44 may be formed on an additional semiconductor substrate (semiconductor integrated circuit die) having a surface such as surface 23 that is attached to surface 19 of image pixels array 17. Control circuitry 44 may be coupled to image pixels in image pixel array 17 using vertical conductive paths (vertical conductive interconnects) 40 (e.g., row interconnects 40R, column interconnects 40C, pixel block interconnects 40B, and/or internal row interconnects 40RI of FIG. 2). Vertical conductive interconnects 40 may be formed from metal conductive paths or other conductive contacts that extend through surface 19 and surface 23. As examples, vertical conductive interconnects 40 may include through-silicon vias that extend through surface 19 and/or surface 23, may include microbumps that protrude from surface 19 into control circuitry substrate 44 through surface 23, may include microbumps that protrude from surface 23 into image pixel array substrate 17 through surface 23, or may include any other suitable conductive paths that vertically couple pixel circuitry in image pixel array 17 to control circuitry 44.

Image pixel array 17 may include one or more layers of dielectric material having metal traces for routing pixel control and readout signals to image pixels 30. Vertical conductive interconnects 40 (e.g., row interconnects 40R, column interconnects 40C, pixel block interconnects 40B, and/or internal row interconnects 40RI of FIG. 2) may be coupled to metal traces in image pixel array 17.

Image data such as signal Vout (FIG. 3) may be passed from pixel output paths 40 (FIG. 3) along interconnects 40 from image pixel array 17 to control circuitry 44. Control signals such as reset control signal RST, row/pixel select signal RS, transfer signal TX or other control signals for operating pixels 30 may be generated using control circuitry 44 and passed vertically to pixels 30 in image pixel array 17 along vertical interconnects 40.

Control circuitry 44 may be configured to operate pixels 30 of image pixel array 17. Control circuitry 44 may include row control circuitry (row driver circuitry) 45, bias circuitry (e.g., source follower load circuits), sample and hold circuitry, correlated double sampling (CDS) circuitry, amplifier circuitry, analog-to-digital (ADC) conversion circuitry 43, data output circuitry, memory (e.g., buffer circuitry), address circuitry, metadata generation circuitry, etc. Control circuitry 44 may be configured to provide bias voltages, power supply voltages or other voltages to image pixel array 17. Control circuitry 44 may be formed as a stacked layer of image pixel array 17 that is coupled to pixel circuitry of pixel array 17 or may be formed on an additional semiconductor integrated circuit die that is coupled to image pixel array 17 using interconnects 40. Some interconnects 40 may be configured to route image signal data from image pixel array 17 to ADC converter 43. Digital image data from ADC converter 43 may then be provided to processing circuitry and storage 50. If desired, metadata corresponding to image data from each block 31 may be generated by control circuitry 44 and stored as an analog voltage or converted to one or more digital values and provided to digital circuitry such as storage and processing circuitry 50. However, this is merely illustrative. If desired, metadata corresponding to image data from each block 31 may be generated by circuitry 50.

Storage and processing circuitry 50 may, for example, be an image coprocessor (ICOP) chip that is stacked with control circuitry 44.

Image data signals read out using control circuitry 44 from photosensitive elements on image pixel array 17 may be passed from control circuitry 44 to storage and processing circuitry 50 that is vertically stacked (e.g., in direction z) with image pixel array 17 and control circuitry 44 along vertical interconnects such as interconnects 46. Vertical interconnects 46 may include through-silicon vias, microbumps or other suitable interconnects that couple metal lines in control circuitry 44 to metal lines in processing circuitry and storage 50.

Circuitry 50 may be partially integrated into control circuitry 44 or may be implemented as a separated semiconductor integrated circuit that is attached to a surface such as surface 27 of control circuitry 44. Image sensor 16 may include additional vertical conductive interconnects 46 such as metal conductive paths or other conductive contacts that extend through surface 27. As examples, vertical conductive interconnects 46 may include through-silicon vias that extend through surface 27, may include microbumps that protrude from surface 27 into processing circuitry substrate 50, or may include any other suitable conductive paths that vertically couple control circuitry 44 to storage and processing circuitry 50.

Processing circuitry 50 may include one or more integrated circuits (e.g., image processing circuits, microprocessors, storage devices such as random-access memory and non-volatile memory, etc.) and may be implemented using components that are separate from control circuitry 44 and/or that form part of control circuitry 44.

Image data that has been captured by image pixel array 17 may be processed and stored using processing circuitry 50. For example, processing circuitry 50 may be configured to perform white balancing, color correction, high-dynamic-range image combination, motion detection, object distance detection, or other suitable image processing on image data such as blocks of image data that have been passed vertically from control circuitry 44 to processing circuitry 50. Processed image data may, if desired, be provided to external equipment (e.g., a computer, other device, or additional processing circuitry such as processing circuitry 18) using wired and/or wireless communications paths coupled to processing circuitry 50.

Processing circuitry 50 may be formed in a vertical stack with image pixels of a stacked-chip image sensor may, for example, select a subset of digital image data to use in constructing a final image and extracting image depth information for the user of system 10. For example, circuitry 50 may be used to combine image data from red, blue, and green sensors to produce full-color images, may be used to determine image parallax corrections, may be used to produce 3-dimensional (sometimes called stereo) images using data from two or more different sensors that have different vantage points when capturing a scene, may be used to produce increased depth-of-field images using data from two or more image sensors, may be used to adjust the content of an image frame based on the content of a previous image frame, may be used to detect moving objects in captured images, may be used to detect particular objects in captured images, may be used for facial recognition operations using captured images, or may be used to otherwise process image data.

In some modes of operation, multiple stacked-chip image sensors on array 16 may be active (e.g., when determining 3-dimensional image depth information). In other modes of operation (e.g., color imaging), only a subset of the image sensors may be used. Other sensors may be inactivated to conserve power (e.g., their positive power supply voltage terminals may be taken to a ground voltage or other suitable power-down voltage and their control circuits may be inactivated or bypassed).

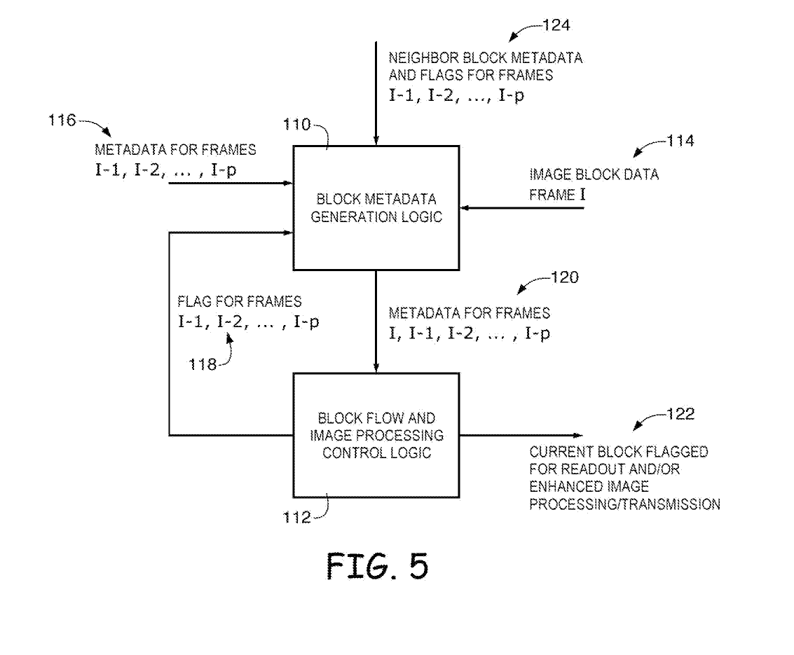

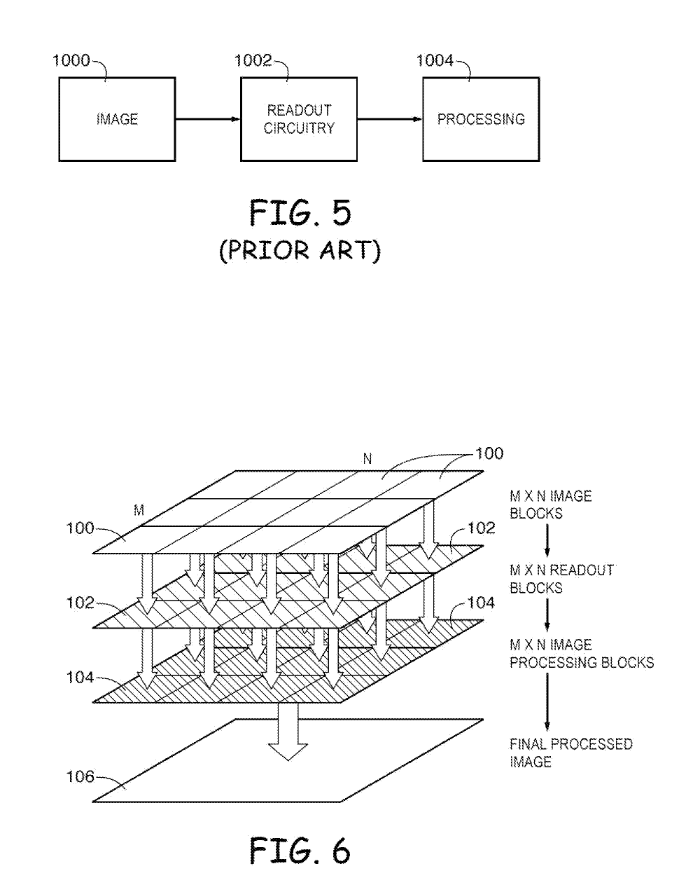

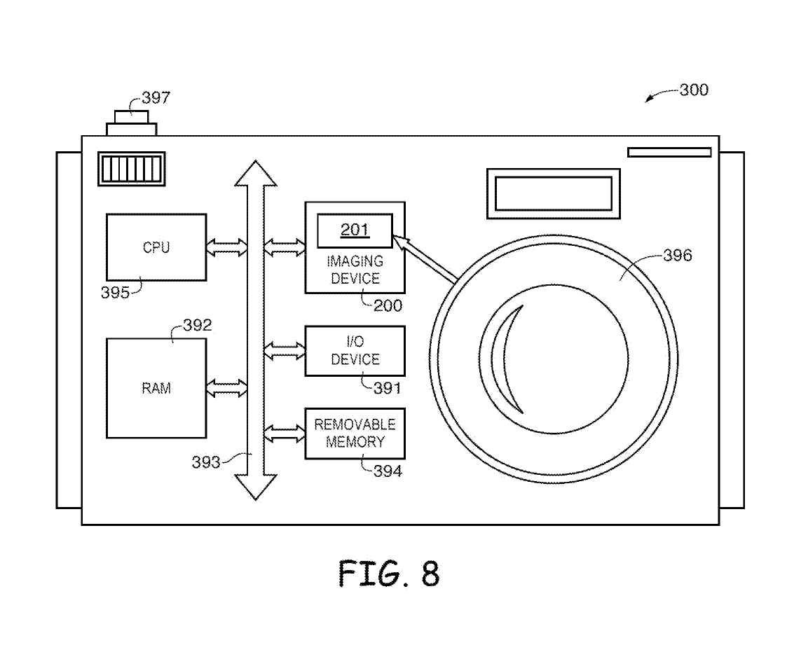

FIG. 5 is a flow diagram showing how an image is processed in a conventional planar image sensor in which readout circuitry and processing circuitry are laterally separated from the image sensor or located on another integrated circuit. As shown in FIG. 5, image 1000 is captured and provided to readout circuitry 1002. Readout circuitry 1002 provides pixel values from image 1000 in series to processing circuitry 1004. Because the entire image is provided to processing circuitry in this way, the efficiency with which image data is processed and analyzed can be limited.

FIG. 6 is a flow diagram showing how image blocks may be read out in parallel and processed in parallel to form a final processed image. As shown in FIG. 6, m×n image blocks 100 (e.g., blocks of image data captured using blocks 31 of FIG. 2) may be read out in parallel (e.g., to analog circuitry 44) to form m x n readout blocks 102. The m×n readout blocks 102 may be read out in parallel (e.g., to digital circuitry 50) to form m×n processing blocks 104. The m×n processing blocks may be processed and combined to form final image 106. In this example, m and n may each be any suitable integer number of image blocks corresponding to blocks 31.

During readout operations of image data captured using one or more pixel arrays 17 (see FIG. 2), metadata may be generated (e.g., using circuitry 44 and/or circuitry 50) based on the content of the image data being read out. Metadata may be generated for each image block 100 (e.g., for the image data that has been captured by each block 31 of the pixel array). The generated metadata may include a flag for each block that indicates whether that image block is suitable for output, that indicates the priority of output of that image block, that indicates that that image block requires enhanced image processing, or that indicates that that image block should undergo other special processing. Metadata flags of this type may be generated based on image block attributes such as color, motion, mean value, object and face recognition, interest points, etc. in the image block.

The generated metadata may be used to control the readout and subsequent image processing of each image data block. Metadata may be stored as an analogue voltage or converted to one or more digital values. Metadata flags for each image block in a particular image frame may be compared with metadata that was generated for that image block or for other image blocks (e.g., surrounding image blocks), for a previous frame or for a number of previous frames. A typical flow for one exemplary image block in this type of system is shown in FIG. 7.

As shown in FIG. 7, processing circuitry such as block metadata generation logic circuitry 110 and block flow and image processing control logic circuitry 112 may be provided for generating metadata associated with image blocks such as image blocks 100 of FIG. 6. Block metadata generation logic circuitry 110 and block flow and image processing control logic circuitry 112 may be implemented as a portion of analog control circuitry 44 or digital circuitry 50 of FIG. 4 (as examples).

Image block data 114 (e.g., one of image blocks 100) for an Ith frame (frame I) may be provided to metadata generation circuitry 110. Circuitry 110 may also be configured to receive metadata 116 for that image block from previously captured frames (e.g., frames I-1, I-2, . . . I-p), additional flags 118 for that image block from previously captured frames (e.g., frames I-1, I-2, . . . I-p), and metadata and flags 124 for other image blocks such as neighboring image blocks from previously captured frames (e.g., frames I-1, I-2, . . . I-p). In this example, p may be any suitable integer number of frames.

If desired, metadata 116 for previous frames may be used to optimize sensor settings for capture and processing of subsequent frames such as the current frame I. As examples, an integration time, a gain, local and global tone mapping settings, or other settings for a current frame may be set using metadata 116 for previous frames.

Based on the content of the image data in block data 114 and, if desired, metadata 116, flags 118, and metadata and flags 124, metadata generation circuitry 110 may generate metadata for block data 114 (i.e., for frame I for that block). Metadata 120 for frame I and for the previous frames for that block may then be provided to block flow and image processing control logic circuitry 112.

In response to receiving metadata 120, control circuitry 112 may output block data 122 for blocks that have been flagged for readout, flagged for enhanced image processing, or otherwise flagged for transmission in metadata 120. Circuitry 112 may reduce the required output bandwidth of the image sensor by outputting only a subset of image blocks 114 that are flagged for transmission in some way in metadata 120.

Using this approach, not all image blocks need be read out or processed, thereby providing time, processing and/or bandwidth savings. The above framework allows for generation of metadata on a basis that is faster than the frame rate output by the sensor. In the case of multiple exposure high dynamic range (HDR) imaging for example, metadata may be generated for each sub-exposure of the sensor which is subsequently combined to form the single output exposure. Metadata for a given image block can, but need not, be transmitted with the image block. If desired, the metadata may be stored at the same location where it is generated. In cases in which the metadata is not transmitted with the image block, metadata can be read by a common readout/decision making circuit, thereby reducing any transmission bandwidth needed for metadata.

Another illustrative example is described in the context of video conferencing. A sensor may be split into blocks of j×k pixels where j and k are any suitable integer number of pixels. Metadata generation for these blocks may be based on a difference between the mean pixel value for the current frame and a previous frame for the block. The difference between the mean pixel values may be compared to a threshold value. If the difference exceeds the threshold value, a difference in the scene for the block may be detected. In response to detecting that difference, metadata flagging that block for processing may be generated. Subsequently, only those blocks that have been flagged for processing may be compressed and output, thereby saving downstream bandwidth. Implemented as a sensor for mobile video conferencing, this approach would save significant host processor time or the need for an image co-processor.

FIG. 10 shows in simplified form a typical processor system 300, such as a digital camera, which includes an imaging device such as imaging device 200 (e.g., an imaging device 200 such as stacked-chip image sensor 16 of FIG. 4). Processor system 300 is exemplary of a system having digital circuits that could include imaging device 200. Without being limiting, such a system could include a computer system, still or video camera system, scanner, machine vision, vehicle navigation, video phone, surveillance system, auto focus system, star tracker system, motion detection system, image stabilization system, and other systems employing an imaging device.

Processor system 300, which may be a digital still or video camera system, may include a lens such as lens 396 for focusing an image onto a pixel array such as pixel array 201 when shutter release button 397 is pressed. Processor system 300 may include a central processing unit such as central processing unit (CPU) 395. CPU 395 may be a microprocessor that controls camera functions and one or more image flow functions and communicates with one or more input/output (I/O) devices 391 over a bus such as bus 393. Imaging device 200 may also communicate with CPU 395 over bus 393. System 300 may include random access memory (RAM) 392 and removable memory 394. Removable memory 394 may include flash memory that communicates with CPU 395 over bus 393. Imaging device 200 may be combined with CPU 395, with or without memory storage, on a single integrated circuit or on a different chip. Although bus 393 is illustrated as a single bus, it may be one or more buses or bridges or other communication paths used to interconnect the system components.

Various embodiments have been described illustrating imaging systems having stacked-chip image sensors. Each stacked-chip image sensor may include a vertical chip stack that includes an array of image pixels, analog control circuitry and digital storage and processing circuitry.

The image pixel array may be coupled to the control circuitry using vertical metal interconnects such as through-silicon vias or microbumps that route image data signals in a direction that is perpendicular to a plane defined by the array of image pixels. The vertical interconnects may include vertical column interconnects, vertical row interconnects, vertical block interconnects, or vertical internal row interconnects along an edge or interspersed within the array of image pixels.

The control circuitry and/or the digital processing circuitry may include block metadata generation logic circuitry and block flow and image processing control logic circuitry that control the processing of blocks of image data from blocks of image pixels in the image pixel array.

The block metadata generation logic circuitry may receive image data from an image frame for a given block, metadata for previous frames for that block, other flags for previous frames for that block, and metadata and flags for neighboring image blocks for previous frames. Based on the received data, the block metadata generation logic circuitry may generate metadata for the current block and provide the generated metadata to the block flow and image processing control logic circuitry.

The block flow and image processing control logic circuitry may output block data for blocks that have been flagged for readout, flagged for enhanced image processing, or otherwise flagged for transmission in the received metadata. In this way, the sensor may reduce the required output bandwidth by outputting only a subset of image blocks for each image frame. Using this approach, not all image blocks need be read out or processed, thereby providing time, processing and/or bandwidth savings.

The foregoing is merely illustrative of the principles of this invention which can be practiced in other embodiments.

What is claimed is:

1. A stacked-chip image sensor, comprising:
a semiconductor substrate having opposing first and second surfaces;
an array of image sensor pixels in the semiconductor substrate that are configured to receive image light through the first surface; and
control circuitry coupled to the array of image sensor pixels by a plurality of vertical conductive interconnects that extend through the second surface, wherein the control circuitry comprises:
metadata generation circuitry; and
image data output control circuitry, wherein the metadata generation circuitry is configured to generate metadata for blocks of image data and wherein the image data output control circuitry is configured to control transmission of the blocks of image data based on the generated metadata.

2. The stacked-chip image sensor defined in claim 1 wherein the metadata comprises an analog voltage stored in the control circuitry.

3. The stacked-chip image sensor defined in claim 1 wherein the metadata comprises a digital value.

4. The stacked-chip image sensor defined in claim 1 wherein the metadata generation circuitry is configured to receive a current frame of image data for a selected one of the blocks of image data.

5. The stacked-chip image sensor defined in claim 4 wherein the metadata generation circuitry is further configured to receive metadata for at least one previous frame of image data for the selected one of the blocks of image data.

6. The stacked-chip image sensor defined in claim 5 wherein the metadata generation circuitry is further configured to receive additional metadata for at least one previous frame of image data for another selected one of the blocks of image data.

7. The stacked-chip image sensor defined in claim 6 wherein the another selected one of the blocks of image data is a neighboring block of the selected one of the blocks of image data.

8. The stacked-chip image sensor defined in claim 7 wherein the metadata generation circuitry is configured to generate the metadata for the blocks of image data using the current frame of image data, the metadata for the at least one previous frame of image data for the selected one of the blocks of image data, and the additional metadata for the at least one previous frame of image data for the another selected one of the blocks of image data.

9. The stacked-chip image sensor defined in claim 8 wherein the metadata generation circuitry is configured to generate the metadata for the blocks of image data by flagging the selected one of the blocks of image data for enhanced image processing.

10. The stacked-chip image sensor defined in claim 8 wherein the metadata generation circuitry is configured to generate the metadata for the blocks of image data by flagging the selected one of the blocks of image data for transmission.

11. The stacked-chip image sensor defined in claim 10 wherein the metadata generation circuitry is configured to flag the selected one of the blocks of image data for transmission by detecting a difference between the current frame of image data for selected one of the blocks of image data and the at least one previous frame of image data for the selected one of the blocks of image data.

12. The stacked-chip image sensor defined in claim 10 wherein the image data output control circuitry is configured to control the transmission of the blocks of image data based on the generated metadata by outputting the selected one of the blocks of image data that has been flagged for transmission.

13. An image sensor, comprising:
an array of stacked-chip image sensors wherein each stacked-chip image sensor comprises:
a semiconductor substrate;
an array of image sensor pixels in the semiconductor substrate; and
circuitry coupled to the array of image sensor pixels by a plurality of vertical conductive interconnects, wherein the circuitry is configured to generate metadata for a plurality of blocks of image data and to control transmission of the plurality of blocks of image data based on the generated metadata.

14. The image sensor defined in claim 13 wherein the circuitry of each stacked-chip image sensor is configured to generate the metadata for the plurality of blocks of image data in parallel.

15. The image sensor defined in claim 14 wherein the circuitry of each stacked-chip image sensor is configured to control the transmission of the plurality of blocks of image data based on the generated metadata by transmitting a subset of the plurality of blocks of image data based on the generated metadata.

16. The image sensor defined in claim 15 wherein the circuitry of each stacked-chip image sensor is configured to transmit a portion of the generated metadata that is associated with the subset of the plurality of blocks of image data along with the subset of the plurality of blocks of image data.

17. The image sensor defined in claim 16, further comprising an array of lenses configured to focus light onto the array of stacked-chip image sensors.

18. The image sensor defined in claim 17 wherein the circuitry is configured to optimize sensor settings for capture and processing of subsequent image frames using the generated metadata.

19. A system, comprising:
a central processing unit;
memory;
input-output circuitry; and
an imaging device, wherein the imaging device comprises:
a stacked-chip image sensor having a pixel array and control circuitry, wherein the control circuitry is configured to generate metadata for a plurality image blocks and control transmission of the plurality of image blocks based on the generated metadata.

20. The system defined in claim 19 wherein each of the plurality of image blocks comprises image data from a block of image pixels in the pixel array that is coupled to the control circuitry by a vertical conductive interconnect.
